(19) United States
(12) Patent Application Publication
(10) Pub. No.: US 2008/0119603 A1
(43) Pub. Date: May 22, 2008

(54) Mobile telephone housing comprising polyamide resin composition

(76) Inventor: Georgios Topoulos, Geneva (CH)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/985,419

(22) Filed: Nov. 15, 2007

Related U.S. Application Data
(60) Provisional application No. 60/860,543, filed on Nov. 22, 2006.

(51) Int. Cl. C08L 33/24

(52) U.S. Cl. 524/514; 524/612

(57) ABSTRACT

A mobile telephone housing comprising a polyamide composition having excellent stiffness and toughness and low warpage.

### CROSS REFERENCE TO RELATED APPLICATIONS

This application claims the benefit of U.S. Provisional Application No. 60/860,543, filed Nov. 22, 2006.

### FIELD OF THE INVENTION

The present invention relates to a mobile telephone housing comprising a polyamide composition having a combination of good stiffness and impact resistance and low warpage after molding.

### BACKGROUND OF THE INVENTION

Mobile (also referred to as “cellular”) telephones are becoming increasingly widely used globally. It is often important that they be made from materials that are able to withstand rigors of frequent use and can meet challenging aesthetic demands while not interfering with the operation of the telephone and its ability to send and receive electromagnetic signals. Mobile telephone housings are a particularly demanding materials application. Mobile telephone housings comprise one or more components that can include the back and front covers, the backbone, and the antenna housing, depending on the design of the telephone.

In many cases the backbone is a frame onto which many of the components of the telephone, such as the screen, keypad, battery socket, microprocessors, other electronic components, antennas, etc., are mounted. In addition to providing structural support for the telephone and many of its components, the backbone may provide the primary protection of many of these components against impact. Covers may provide additional protection from impact and protect the backbone and internal components from contamination. Covers may also provide substantial or primary structural support for and protection against impact of certain components, such as screens and/or antennas. Furthermore, there are often substantial aesthetic demands placed on the appearance of covers and other mobile telephone housing elements. It is thus often important that the materials used for mobile telephone housings have high modulus, impact resistances, and low degrees of warpage. By “warpage” is meant the deformation of molded parts in one or more directions that may be caused by anisotropic shrinkage of the resin during molding.

Thermoplastic polyamide compositions are desirable for use in making mobile telephone housings because of their good physical properties and that they may be conveniently and flexibly molded into a variety of articles of varying degrees of complexity and intricacy. However, many such compositions that have good stiffness and impact resistant suffer from increased warpage that may be unacceptable many applications. Furthermore the use of many reinforcing agents that can provide compositions having acceptable degrees of stiffness and warpage yield compositions that are insufficiently impact resistant. It would thus be desirable to obtain mobile telephone housings made from polyamide compositions having a good balance of physical properties between good stiffness and impact resistance and low warpage.

### SUMMARY OF THE INVENTION

There is disclosed and claimed herein a mobile telephone housing, comprising a polyamide composition comprising,
(A) about 25 to about 67 weight percent of at least one polyamide;
(B) about 30 to about 65 weight percent of one or more reinforcing agents comprising (i) glass fibers, and (ii) glass flakes, wherein the weight ratio of fibers (i) to flakes (ii) is between about 1:6 to about 6:1; and
(C) about 3 to about 20 weight percent of one or more impact modifiers; wherein the weight percentages of (a) and (b) are based on the total weight of (a)+(b) and the weight percentages of (A), (B), and (C) are based on the total weight of (A)+(B)+(C), and the composition has a tensile modulus greater than or equal to about 9 GPa, as measured by ISO 527-1/2.

The instant invention provides mobile telephone housings comprising polyamide compositions having excellent stiffness and toughness and low warpage. There is claimed a wide range of materials useful for practice of the instant invention, for example a variety of impact modifiers and polyamides may be selected which are suitable for these applications, as detailed further herein.

### DETAILED DESCRIPTION OF THE INVENTION

By “mobile telephone housing” (also referred to herein as “housings”) is meant one or more of the back cover, front cover, antenna housing, and/or backbone of a mobile phone. The housing may be a single article incorporating one or more of the foregoing. By “backbone” is meant a structural component onto which other components of the mobile telephone, such as electronics, screens, battery sockets, and the like are mounted. The backbone may be an interior component that is not visible or only partially visible from the exterior of the telephone.

The housing comprises a composition comprising a melt-mixed blend of at least one thermoplastic polyamide (A), reinforcing agent (B) comprising glass fibers and glass flakes, and at least one impact modifier (C).

Thermoplastic polyamide (A) is at least one polyamide. Suitable polyamides can be condensation products of one or more dicarboxylic acids and one or more diamines, and/or one or more aminocarboxylic acids, and/or ring-opening polymerization products of one or more cyclic lactams.

Suitable dicarboxylic acids include, but are not limited to, adipic acid, azelaic acid, terephthalic acid (abbreviated as “T” in polyamide designations), and isophthalic acid (abbreviated as “I” in polyamide designations). Preferred are dicarboxylic acids having 10 or more carbon atoms, including, but not limited to sebacic acid; dodecanedioic acid, tetradecanedioic acid, pentadecanedioic acid, and the like.

Suitable diamines include, but are not limited to, tetramethylenediamine; hexamethylenediamine; octamethylenediamine; nonamethylenediamine; 2-methylpentamethylenediamine; 2-methyloctamethylenediamine; trimethylhexamethylenediamine; bis(p-aminocyclohexyl)methane; m-xylylenediamine; and p-xylylenediamine. Preferred diamines have 10 or more carbon atoms, including, but not limited to decamethylenediamine; undecamethylenediamine; dodecamethylenediamine; tridecamethylenediamine; tetramethylenediamine; pentamethylenediamine; hexamethylenediamine; and the like.

A suitable aminocarboxylic acid is 11-aminododecanoic acid. Suitable cyclic lactams are caprolactam and laurolactam.

Preferred polyamides include aliphatic polyamides such as polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; polyamide 6,13; and semi-aromatic polyamides such as poly(m-xylylene adipamide) (polyamide MXD,6), poly(dodecamethylene terephthalamide) (polyamide 12,T), poly(decamethylene terephthalamide) (polyamide 10,T), poly(nonamethylene terephthalamide) (polyamide 9,T), hexamethylene adipamide/hexamethylene terephthalamide copolyamide (polyamide 6,T/6,6), hexamethylene terephthalamide/2-methylpentamethylene terephthalamide copolyamide (polyamide 6,T/D,T); and copolymers and mixtures of these polymers.

The polyamides may be amorphous polyamides or semicrystalline. An example of a suitable amorphous polyamide includes hexamethylene terephthalamide/hexamethylene isophthalamide (6,T/6,I) copolymer.

Reinforcing agent (B) is present in the composition about 30 to about 65 weight percent, or preferably in about 35 to about 55 weight percent, or more preferably in about 40 to about 50 weight percent, based on the total weight of components (A)+(B)+(C). Reinforcing agent (B) comprises glass fibers and glass flakes. The glass fibers and glass flakes are present in a weight ratio of about 1:6 to about 6:1, or more preferably in a ratio of about 1:2 to about 2:1 or yet more preferably in a ratio of about 3:2 to about 2:3. The glass fibers have a fibrous or needlelike form and a number average aspect ratio of at least about 3. The glass flakes may have a flaky or platy form.

Impact modifier (C) is present in the composition in about 3 to about 20 weight percent, or more preferably in about 5 to about 15 weight percent, based on the total weight of components (A)+(B)+(C).

Preferred impact modifiers include those typically used for polyamides, including carboxyl-substituted polyolefins, which are polyolefins that have carboxylic moieties attached thereto, either on the polyolefin backbone itself or on side chains. By “carboxylic moieties” is meant carboxylic groups such as one or more of dicarboxylic acids, diesters, dicarboxylic monoesters, acid anhydrides, and monocarboxylic acids and esters. Useful impact modifiers include dicarboxyl-substituted polyolefins, which are polyolefins that have dicarboxylic moieties attached thereto, either on the polyolefin backbone itself or on side chains. By ‘dicarboxylic moiety’ is meant dicarboxylic groups such as one or more of dicarboxylic acids, diesters, dicarboxylic monoesters, and acid anhydrides.

The impact modifier may preferably be based on an ethylene/α-olefin polyolefin. Diene monomers such as 1,4-hexadiene or dicyclopentadiene may optionally be used in the preparation of the polyolefin. Preferred polyolefins are ethylene-propylene-diene (EPDM) polymers made from 1,4-hexadiene and/or dicyclopentadiene. The carboxyl moiety may be introduced during the preparation of the polyolefin by copolymerizing with an unsaturated carboxyl-containing monomer. Preferred is a copolymer of ethylene and maleic anhydride monoethyl ester. The carboxyl moiety may also be introduced by grafting the polyolefin with an unsaturated compound containing a carboxyl moiety, such as an acid, ester, diacid, diester, acid ester, or anhydride. A preferred grafting agent is maleic anhydride. A preferred impact modifier is an EPDM polymer grafted with maleic anhydride, such as Fusabond® N MF521D, which is commercially available from E. I. DuPont de Nemours & Co., Inc., Wilmington, Del. Blends of polyolefins, such as polyethylene, polypropylene, and EPDM polymers with polyolefins that have been grafted with an unsaturated compound containing a carboxyl moiety may be used as an impact modifier.

Suitable impact modifiers may also include ionomers. By an ionomer is meant a carboxyl group containing polymer that has been neutralized or partially neutralized with metal cations such as zinc, sodium, or lithium and the like. Examples of ionomers are described in U.S. Pat. Nos. 3,264,272 and 4,187,358, both incorporated by reference herein. Examples of suitable carboxyl group containing polymers include, but are not limited to, ethylene/acrylic acid copolymers and ethylene/methacrylic acid copolymers. The carboxyl group containing polymers may also be derived from one or more additional monomers, such as, but not limited to, butyl acrylate. Zinc salts are preferred neutralizing agents. Ionomers are commercially available under the Surlyn® trademark from E.I. du Pont de Nemours and Co., Wilmington, Del.

The compositions used in the present invention may optionally comprise additional additives such as ultraviolet light stabilizers, heat stabilizers, antioxidants, processing aids, lubricants, flame retardants, colorants (including dyes, pigments, carbon black, and the like), fillers, and additional reinforcing agents such as carbon fibers and minerals such as wollastonite.

The compositions used in the present invention have a tensile modulus that is at least about 8 GPa, or preferably at least about 9 GPa, or more preferably at least about 10 GPa. Tensile modulus is determined according to the ISO 527-1/2 method. Test specimens are elongated at a constant rate of 1 mm/min. The tensile modulus E is determined using Young's law by measuring the forces F1 and F2 needed to elongate test specimens to 0.05 percent (e1) and 0.25 percent (e2):

E=(F2−F1)/(S*(e2−e1))

where S is the cross section (transversal section) of the test specimen.

The test specimens used are tensile type 1B with a radius r of 60 mm, which are described into the ISO procedure and obtained by injection molding. Test specimens are placed into sealed bags immediately after molding until testing in order to prevent moisture pick up. Tensile modulus is measured for 8 specimens for each polymer and the results is the average of them. Cross section S is determined for each sample by measuring its thickness and its breadth.

The compositions used in the present invention preferably have notch Charpy impact strength of at least about 8 kJ/m², or more preferable of at least about 9 kJ/m², or yet more preferably of about 10 kJ/m². Notched Charpy impact strength is measured according to ISO 179 using test specimens prepared according to ISO 179-1/1eA. The energy E necessary to break the specimen is measure and Charpy impact strength is calculated by dividing the energy E by the cross-sectional area of the specimen. The impact strength is average of the results from testing 10 specimens

The compositions used in the present invention preferably have a warpage of less than about 0.45, or more preferably of less than about 0.40, or yet more preferably of less than about 0.35. Warpage is determined as follows: Compositions are injection molded into plaques having dimension of 60×60×2 mm according to ISO 29 4-3. Following molding and cooling, the widths of the plaques in the flow and cross-flow directions were measured. The flow direction is defined by the direction into which the molten resin was injected into the mold and the cross-flow direction is perpendicular across the surface of the plaque relative to the flow direction. The percentage by which the plaques had shrunken in each direction was calculated relative to the mold dimensions. The warpage is the absolute value of the percent shrinkage in the cross-flow direction minus the percent shrinkage in the flow direction.

The compositions used in the present invention are made by melt-blending the components using any known methods. The component materials may be mixed to uniformity using a melt-mixer such as a single or twin-screw extruder, blender, kneader, Banbury mixer, etc. to give a resin composition. Or, part of the materials may be mixed in a melt-mixer, and the rest of the materials may then be added and further melt-mixed until uniform.

The mobile telephone housing is made from the compositions using any suitable melt-processing method. Injection molding is a preferred method.

### EXAMPLES

The compositions of the examples (referred to in the tables as “Ex.”) and comparative examples (referred to in the tables as “CE”) were prepared by melt blending the ingredients shown in Tables 1, 3, 5, and 7 in a twin-screw extruder. The resulting compositions were molded into test specimens for determining tensile and impact properties and warpage. The results of the test are shown in Tables 2, 4, 6, and 8.

Comparative Example 10 is Zytel® HTN 53GM40 HSL BK 083 and Comparative Example 18 is Zytel® HTN 53G50LR HSL BL518, both of which are commercially available from E.I. du Pont de Nemours and Co., Wilmington, Del.

Tensile properties (tensile modulus, stress at break, and strain at break) were measured according to ISO 157-1/2 at 23° C. on samples that were dry as molded.

Impact properties (unnotched Charpy and notched Charpy impact strengths) were measured according to ISO 179/1eA at 23° C. on samples that were dry as molded.

Warpage properties shown in Tables 2 and 4 were measured by injection molding 20 cm×4 cm×1.5 test specimens. Following molding and cooling, the widths of the specimens in the flow and cross-flow directions were measured. The flow direction is defined by the direction into which the molten resin was injected into the mold and the cross-flow direction is perpendicular across the surface of the plaque relative to the flow direction. Measurements were taken at a point on the specimens near the gate and at a point far from the gate. The percentage by which the plaques had shrunken in each direction (referred to in the tables as “flow direction” and “cross-flow direction”) was calculated relative to the mold dimensions. The warpage is the percent shrinkage in the cross-flow direction minus the percent shrinkage in the flow direction.

Warpage properties shown in Table 8 were measured as described above under the Detailed Description of the Invention.

The following components are referred in the tables:

Glass fibers refers to E-glass fibers having a number average diameter of about 10 microns.

Glass flakes refers to REF 160 A supplied by NGF.

Polarite® 402 refers to calcinced China clay supplied by ECC International, Cornwall UK.

Translink® 555 refers to calcined kaolin supplied by Engelhard, Iselin N.J.

10 Wollastocoat® 10802, 475 Wollastocoat® 10802, Nyglos® M3 10802, Nyglos® 4W 10802, Nyglos® 8, and Nyad® 475 refer to wollastonites supplied by Nyco Minerals, Willsboro, N.Y.

Naintsch® A-60 refers to mica supplied by Naintsch Mineralwerke, Graz.

PA 6,T/D,T refers to hexamethylene terephthalamide/2-methylpentamethylene terephthalamide copolyamide.

PA 6,6/6,T refers to hexamethylene adipamide/hexamethylene terephthalamide copolyamide.

PA 6,I/6,T refers to hexamethylene terephthalamide/hexamethylene isophthalamide copolymer.

Impact modifier refers to ethylene/propylene/diene copolymers partially grafted with maleic anhydride.

Color concentrate A refers to a master batch containing about 30 weight percent carbon black in polyamide 6.

Color concentrate C refers to a master batch containing about 40 weigh percent of a blue pigment in polyamide 6.

Lubricant refers to fatty acid salt or esters.

TABLE 1

| | CE 1 | CE 2 | CE 3 | CE 4 | CE 5 | CE 6 | CE 7 | CE 8 | CE 9 | Ex. 1 |
|---|---|---|---|---|---|---|---|---|---|---|
| Glass fibers | 50 | 30 | 30 | 30 | 30 | 30 | 30 | 30 | 30 | 30 |
| Polarite ® 402 | — | 20 | — | — | — | — | — | — | — | — |
| Translink ® 555 | — | — | 20 | — | — | — | — | — | — | — |
| 10 Wollastocoat ® | — | — | — | 20 | — | — | — | — | — | — |
| 10802 | | | | | | | | | | |
| 475 Wollastocoat ® | — | — | — | — | 20 | — | — | — | — | — |
| 10802 | | | | | | | | | | |
| Nyglos ® M3 10802 | — | — | — | — | — | 20 | — | — | — | — |
| Nyglos ® 4W 10802 | — | — | — | — | — | — | 20 | — | — | — |
| Nyad ® 475 | — | — | — | — | — | — | — | 20 | — | — |
| Naintsch ® A-60 | — | — | — | — | — | — | — | — | 20 | — |
| Glass flakes | — | — | — | — | — | — | — | — | — | 20 |
| PA 6, T/D, T | 17.7 | 17.7 | 17.7 | 17.7 | 17.7 | 17.7 | 17.7 | 17.7 | 17.7 | 17.7 |
| PA 6, 6/6, T | 17.7 | 17.7 | 17.7 | 17.7 | 17.7 | 17.7 | 17.7 | 17.7 | 17.7 | 17.7 |
| PA 6, I/6, T | 8.5 | 8.5 | 8.5 | 8.5 | 8.5 | 8.5 | 8.5 | 8.5 | 8.5 | 8.5 |
| Impact modifier | 5 | 5 | 5 | 5 | 5 | 5 | 5 | 5 | 5 | 5 |
| Stabilizers | 1.1 | 1.1 | 1.1 | 1.1 | 1.1 | 1.1 | 1.1 | 1.1 | 1.1 | 1.1 |

Ingredient quantities are given in weight percentages based on the total weight of the composition

TABLE 2

| | CE 1 | CE 2 | CE 3 | CE 4 | CE 5 | CE 6 | CE 7 | CE 8 | CE 9 | CE 10 | Ex. 1 |
|---|---|---|---|---|---|---|---|---|---|---|---|
| Tensile modulus (GPa) | 17.2 | 12.1 | 12.5 | 12.5 | 12.3 | 13.1 | 14.2 | 12.6 | 13.8 | 12.1 | 14.5 |
| Stress at break (MPa) | 239 | 159 | 160 | 172 | 165 | 172 | 184 | 170 | 149 | 157 | 186 |
| Strain at break (%) | 2.7 | 2 | 2 | 2.4 | 2.1 | 2.1 | 2.2 | 2.3 | 1.9 | 2.3 | 2.6 |
| Notched Charpy impact | 12.3 | 5.2 | 4.8 | 6.9 | 6.1 | 5.3 | 5.9 | 6.6 | 6 | 4 | 10 |
| strength (kJ/m²) | | | | | | | | | | | |
| Unnotched Charpy | 82 | 49 | 48 | 54 | 50 | 46 | 55 | 52 | 25 | 50 | 64 |
| impact strength (kJ/m²) | | | | | | | | | | | |
| Mold shrinkage: | | | | | | | | | | | |
| Near the gate: | | | | | | | | | | | |
| Flow direction (%) | 0.18 | 0.31 | 0.28 | 0.24 | 0.22 | 0.25 | 0.24 | 0.25 | 0.25 | 0.34 | 0.21 |
| Cross-flow direction | 0.5 | 0.85 | 0.75 | 0.57 | 0.5 | 0.6 | 0.63 | 0.56 | 0.64 | 0.77 | 0.41 |
| (%) | | | | | | | | | | | |
| Warpage | 0.32 | 0.54 | 0.47 | 0.33 | 0.28 | 0.35 | 0.39 | 0.31 | 0.39 | 0.43 | 0.2 |
| Far from the gate: | | | | | | | | | | | |
| Flow direction (%) | 0.06 | 0.17 | 0.14 | 0.08 | 0.07 | 0.1 | 0.09 | 0.09 | 0.13 | 0.12 | 0.11 |
| Cross-flow direction | 0.76 | 1.48 | 0.99 | 0.98 | 0.79 | 1.01 | 1.04 | 0.89 | 0.98 | 0.95 | 0.66 |
| (%) | | | | | | | | | | | |
| Warpage | 0.7 | 1.31 | 0.85 | 0.9 | 0.72 | 0.91 | 0.95 | 0.8 | 0.85 | 0.83 | 0.55 |

TABLE 3

| | Ex. 2 | Ex. 3 | CE 11 | CE 12 | CE 13 | CE 14 | CE 15 | CE 16 | CE 17 |
|---|---|---|---|---|---|---|---|---|---|
| Glass fibers | 30 | 28 | 24.5 | 15 | 25 | 15 | 25 | 15 | 25 |
| Glass flakes | 20 | 18 | 14.5 | — | — | — | — | 25 | 15 |
| PA 6, T/D, T | 17.7 | 16.7 | 21.7 | — | — | — | — | — | — |
| PA 6, 6/6, T | 17.7 | 16.7 | 21.7 | — | — | — | — | — | — |
| PA 6, I/6, T | 8.5 | 7.5 | 12.5 | 16.7 | 16.7 | 14.2 | 14.2 | 16.7 | 16.7 |
| Polyamide 6,6 | — | — | — | 38.45 | 38.45 | 35.95 | 35.95 | 38.45 | 38.45 |
| Impact modifier | 5 | 8 | — | — | — | 5 | 5 | — | — |
| Color concentrate A | — | 4 | 4 | 4 | 4 | 4 | 4 | 4 | 4 |
| Stabilizers | 1.1 | 1.1 | 1.1 | 0.6 | 0.6 | 0.6 | 0.6 | 0.6 | 0.6 |
| Nyglos ® 8 | — | — | — | 25 | 15 | 25 | 15 | — | — |
| Lubricant | — | — | — | 0.25 | 0.25 | 0.25 | 0.25 | 0.25 | 0.25 |

Ingredient quantities are given in weight percentages based on the total weight of the composition

TABLE 4

| | Ex. 2 | Ex. 3 | CE 11 | CE 12 | CE 13 | CE 14 | CE 15 | CE 16 | CE 17 | CE 18 |
|---|---|---|---|---|---|---|---|---|---|---|
| Tensile modulus (GPa) | 14.5 | 12 | 13.4 | 12.6 | 12.6 | 11.4 | 11.4 | 11.8 | 12.7 | 17 |
| Stress at break (MPa) | 200 | 145 | 183 | 163 | 177 | 135 | 150 | 163 | 184 | 234 |
| Strain at break (%) | 3.1 | 2.7 | 1.8 | 2.4 | 2.4 | 2.3 | 2.7 | 2.6 | 2.7 | 2.8 |
| Notched Charpy impact | 10.9 | 10.3 | 4 | 4.1 | 5.3 | 4.7 | 8 | 5.1 | 6.3 | 12 |
| strength (kJ/m²) | | | | | | | | | | |
| Unnotched Charpy | 64 | 53 | 33 | 49 | 54 | 48 | 59 | 39 | 53 | 89 |
| impact strength (kJ/m²) | | | | | | | | | | |
| Mold shrinkage: | | | | | | | | | | |
| Near the gate: | | | | | | | | | | |
| Flow direction (%) | 0.18 | 0.22 | 0.20 | 0.32 | 0.31 | 0.33 | 0.33 | 0.28 | 0.26 | 0.24 |
| Cross-flow direction | 0.39 | 0.51 | 0.41 | 0.83 | 0.85 | 0.88 | 0.87 | 0.57 | 0.62 | 0.77 |
| (%) | | | | | | | | | | |
| Warpage | 0.20 | 0.28 | 0.21 | 0.52 | 0.55 | 0.55 | 0.54 | 0.30 | 0.37 | 0.53 |
| Far from the gate: | | | | | | | | | | |
| Flow direction (%) | 0.13 | 0.16 | 0.13 | 0.11 | 0.09 | 0.10 | 0.09 | 0.14 | 0.12 | 0.04 |
| Cross-flow direction | 0.79 | 0.76 | 0.53 | 0.97 | 0.94 | 0.96 | 1.03 | 0.60 | 0.71 | 0.88 |
| (%) | | | | | | | | | | |
| Warpage | 0.66 | 0.60 | 0.40 | 0.86 | 0.84 | 0.86 | 0.94 | 0.46 | 0.60 | 0.85 |

TABLE 5

| | Ex. 4 | Ex. 5 | Ex. 6 | Ex. 7 | Ex. 8 | Ex. 9 | Ex. 9 | Ex. 10 | Ex. 11 | Ex. 12 | Ex. 13 |
|---|---|---|---|---|---|---|---|---|---|---|---|
| Glass fibers | 19.5 | 18.0 | 19.5 | 19.5 | 19.5 | 18.0 | 18.0 | 19.5 | 18.0 | 18.0 | 19.5 |
| Glass flakes | 24.5 | 28.0 | 24.5 | 24.5 | 24.5 | 28.0 | 28.0 | 24.5 | 28.0 | 28.0 | 24.5 |
| PA 6,T/D,T | 16.3 | — | 16.7 | 16.7 | 16.7 | — | — | 16.7 | — | — | 16.3 |
| PA 6,6/6,T | 16.3 | — | 16.7 | 16.7 | 16.7 | — | — | 16.7 | — | — | 16.3 |
| PA 6,I/6,T | 7.5 | 10.9 | 7.7 | — | — | 10.9 | 10.8 | | 11.0 | | 7.5 |
| Polyamide 6,6 | — | 27.5 | — | 7.7 | — | — | — | — | — | — | — |
| Polyamide 6 | — | — | — | — | 7.7 | 27.5 | 27.5 | — | — | — | — |
| Polyamide 6,12 | — | — | — | — | — | — | — | — | 28.0 | 39.0 | — |
| Impact modifier | 10.0 | 10.0 | 10.0 | 10.0 | 10.0 | 10.0 | 10.0 | 10.0 | 10.0 | 10.0 | 10.0 |
| Color concentrate A | 4.8 | 4.8 | 3.9 | 3.9 | 3.9 | 4.8 | 4.8 | 4.8 | 4.8 | 4.8 | 4.8 |
| Stabilizers | 1.1 | 0.7 | 0.9 | 0.9 | 0.9 | 0.6 | 0.7 | 0.9 | 0.9 | 0.9 | 1.1 |
| Nyglos ® 8 | 0.3 | 0.3 | 0.3 | 0.3 | 0.3 | 0.3 | 0.3 | 0.3 | 0.3 | 0.3 | 0.3 |
| Lubricant | 19.5 | 18.0 | 19.5 | 19.5 | 19.5 | 18.0 | 18.0 | 19.5 | 18.0 | 18.0 | 19.5 |

Ingredient quantities are given in weight percentages based on the total weight of the composition

TABLE 6

| | Ex. 4 | Ex. 5 | Ex. 6 | Ex. 7 | Ex. 8 | Ex. 9 | Ex. 9 | Ex. 10 | Ex. 11 | Ex. 12 | Ex. 13 |
|---|---|---|---|---|---|---|---|---|---|---|---|
| Tensile modulus (GPa) | 10.6 | 10.5 | 10.9 | 10.9 | 10.6 | 10.2 | 10.3 | 10.9 | 10 | 10 | 10.2 |
| Stress at break (MPa) | 127 | 117 | 139.1 | 131.4 | 131.7 | 119.0 | 111.0 | 139.1 | 120 | 108 | 111 |
| Strain at break (%) | 2.9 | 3.5 | 3.2 | 3.0 | 3.1 | 3.4 | 3.0 | 3.2 | 3.0 | 3.4 | 2.9 |
| Notched Charpy impact | 10.2 | 12.1 | 10.2 | 10.4 | 10.1 | 12.6 | 11.2 | 10.2 | 11.7 | 12.2 | 12.6 |
| strength (kJ/m²) | | | | | | | | | | | |
| Unnotched Charpy | 52 | 55 | 58.1 | 54.9 | 55 | 56 | 48.5 | 58.1 | 51.5 | 49.6 | 49.6 |
| impact strength (kJ/m²) | | | | | | | | | | | |

TABLE 7

| | CE 19 | CE 20 | Ex. 14 | CE 21 | Ex. 15 | Ex. 16 | Ex. 17 | Ex. 18 | CE 22 | Ex. 19 |
|---|---|---|---|---|---|---|---|---|---|---|
| Glass fibers | 52.5 | 52.5 | 40 | 50 | 45 | 45 | 20 | 20 | 50 | 18 |
| Glass flakes | — | — | 15 | — | 10 | 15 | 30 | 30 | — | 28 |
| PA 6,I/6,T | — | — | — | — | — | — | — | — | — | 11.6 |
| Polyamide 10,10 | 89.6 | 92.1 | 77.1 | 87.1 | 77.1 | 72.1 | 39.79 | — | — | — |
| Polyamide 6,6 | — | — | — | — | — | — | — | — | — | 30.37 |
| Polyamide 6,14 | — | — | — | — | — | — | — | 39.79 | 47.9 | — |
| Impact modifier | 7.5 | 5 | 5 | 10 | 10 | 10 | 8.1 | 8.1 | — | 10 |
| Color concentrate B | 2 | 2 | 2 | 2 | 2 | 2 | 1.2 | 1.2 | 1.2 | 1.13 |
| Stabilizers | 0.9 | 0.9 | 0.9 | 0.9 | 0.9 | 0.9 | 0.9 | 0.9 | 0.9 | 0.9 |

Ingredient quantities are given in weight percentages based on the total weight of the composition

TABLE 8

| | CE 19 | CE 20 | Ex. 14 | CE 21 | Ex. 15 | Ex. 16 | Ex. 17 | Ex. 18 | CE 22 | Ex. 19 |
|---|---|---|---|---|---|---|---|---|---|---|
| Tensile modulus (GPa) | 14.0 | 14.8 | 13.9 | 12.7 | 12.7 | 13.0 | 8.5 | 10.3 | 15.0 | 10.3 |
| Stress at break (MPa) | 163 | 178 | 157 | 149 | 134 | 123 | 106 | 114 | 200 | 131 |
| Strain at break (%) | 4.2 | 3.6 | 3.6 | 4.2 | 4.3 | 3.9 | 4.3 | 4.4 | 3.4 | 3.9 |
| Notched Charpy impact | 23.2 | 17.7 | 16.2 | 25.6 | 22.0 | 19.6 | 17.6 | 17.1 | 14.5 | 16.5 |
| strength (kJ/m²) | | | | | | | | | | |
| Unnotched Charpy | 74.6 | 75.7 | 65.3 | 71.3 | 61.7 | 51.8 | 57.3 | 63.3 | 92.1 | 69.3 |
| impact strength (kJ/m²) | | | | | | | | | | |
| Mold shrinkage: | | | | | | | | | | |
| Flow direction (%) | 0.80 | 0.80 | 0.66 | 0.80 | 0.69 | 0.49 | 0.57 | 0.62 | 0.88 | 0.56 |
| Cross-flow direction | 0.25 | 0.24 | 0.26 | 0.28 | 0.36 | 0.42 | 0.26 | 0.30 | 0.28 | 0.25 |
| (%) | | | | | | | | | | |
| Warpage | 0.56 | 0.57 | 0.40 | 0.52 | 0.34 | 0.06 | 0.31 | 0.32 | 0.60 | 0.32 |

What is claimed is:

1. A mobile telephone housing, comprising a polyamide composition comprising,
(A) about 25 to about 67 weight percent of at least one polyamide;
(B) about 30 to about 65 weight percent of one or more reinforcing agents comprising (i) glass fibers, and (ii) glass flakes, wherein the weight ratio of fibers (i) to flakes (ii) is between about 1:6 to about 6:1; and
(C) about 3 to about 20 weight percent of one or more impact modifiers;
wherein the weight percentages of (a) and (b) are based on the total weight of (a)+(b) and the weight percentages of (A), (B), and (C) are based on the total weight of (A)+(B)+(C), and the composition has a tensile modulus greater than or equal to about 9 GPa, as measured by ISO 527-1/2.

2. The housing of claim 1, wherein the composition has a tensile modulus greater than or equal to about 10 GPa, as measured by ISO 527-1/2.

3. The housing of claim 1, wherein the composition has a tensile modulus greater than or equal to about 11 GPa, as measured by ISO 527-1/2.

4. The housing of claim 1, wherein the weight ratio of fibers (i) to flakes (ii) is between about 1:2 to about 2:1.

5. The housing of claim 1, wherein the weight ratio of fibers (i) to flakes (ii) is between about 2:3 to about 3:2.

6. The housing of claim 1, wherein the impact modifier (C) comprises one or more carboxyl-substituted polyolefins.

7. The housing of claim 6, wherein the impact modifier (C) comprises one or more carboxyl-substituted ethylene/α-olefin polyolefins.

8. The housing of claim 7, wherein the impact modifier (C) comprises one or more carboxyl-substituted ethylene-propylene-diene polymers.

9. The housing of claim 1, wherein the polyamide (A) comprises one or more of hexamethylene terephthalamide/hexamethylene isophthalamide copolymer; hexamethylene adipamide/hexamethylene terephthalamide copolyamide; and hexamethylene terephthalamide/2-methylpentamethylene terephthalamide copolyamide.

10. The housing of claim 1, wherein the polyamide (A) comprises one or more of polyamide 6; polyamide 6,6; polyamide 4,6; polyamide 6,10; polyamide 6,12; polyamide 11; polyamide 12; polyamide 9,10; polyamide 9,12; polyamide 9,13; polyamide 9,14; polyamide 9,15; polyamide 6,16; polyamide 9,36; polyamide 10,10; polyamide 10,12; polyamide 10,13; polyamide 10,14; polyamide 12,10; polyamide 12,12; polyamide 12,13; polyamide 12,14; polyamide 6,14; polyamide 6,13; polyamide 6,15; polyamide 6,16; and polyamide 6,13.

11. The housing of claim 1, wherein: the polyamide (A) comprises one or more of poly(dodecamethylene terephthalamide), poly(decamethylene terephthalamide), and poly(nonamethylene terephthalamide).
